(19) United States
(12) Patent Application Publication
(10) Pub. No.: US 2010/0097044 A1
(43) Pub. Date: Apr. 22, 2010

(54) Power optimization of operating multiple power supplies

(76) Inventor: Kirk P. Gipson, Roseville, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/288,102

(22) Filed: Oct. 16, 2008

(51) Int. Cl. G05F 1/618

(52) U.S. Cl. 323/285

(57) ABSTRACT

Apparatus and a method of optimizing operating efficiency of multiple power supplies that are provided to power a system, the power supplies being selectively operable in an active or standby mode, said method comprising the steps of interconnecting at least some of the multiple power supplies in a load sharing configuration monitoring the output current of at least one of the interconnected power supplies selectively placing the interconnected power supplies in standby mode so that the active power supplies are operating at a relatively high efficiency.

### BACKGROUND OF THE INVENTION

The amount of power that is required to run large computer networks or computer installations that have a large number of servers can be very expensive. It is common to employ multiple power supplies in parallel to power multiple servers, switches, routers and the like. Even for smaller scale systems, multiple power supplies are often required. The cost of power consumed is desirably minimized, and therefore operating the power supplies that are connected in a system in an efficient manner lowers operating costs of the system.

Another reason for wanting to operate multiple power supplies in an efficient manner is to reduce the heat that is often generated during operation, which can be considered wasted energy. When multiple power supplies operate at a low percentage of their rated output current, i.e., from 25% to 40%, they are inefficient, and can burn up more than one third of the input power in heat.

### DESCRIPTION OF THE DRAWINGS

FIG. 1 is a representative graph of efficiency of a typical power supply used to power computer network devices as a function of being operated at various percentages of rated output current; and

FIG. 2 is a simplified circuit diagram of a plurality of power supplies connected in parallel and being controlled in accordance with an embodiment of this present invention.

### DETAILED DESCRIPTION OF THE PREFERRED EMBODIMENTS

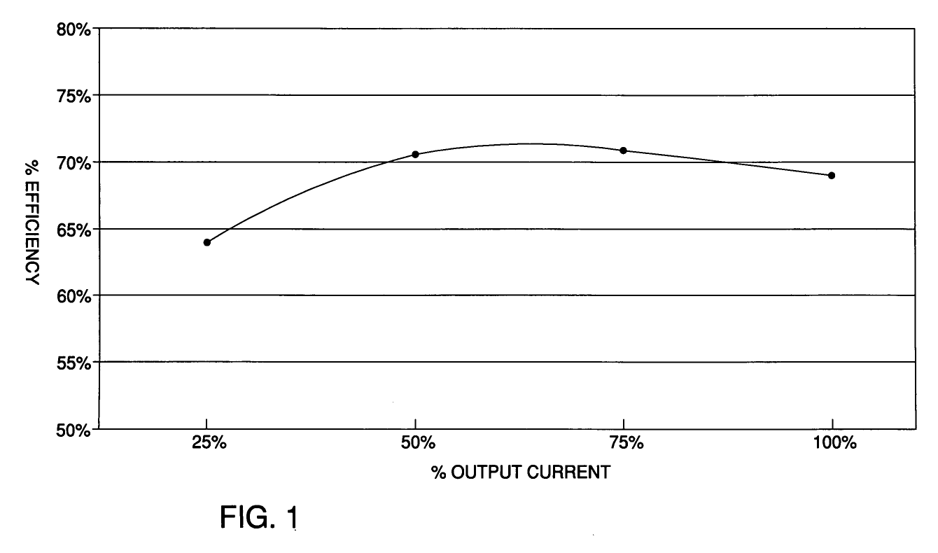

When multiple power supplies are connected together in parallel to power network devices in a computer network, the number of them is necessarily determined as a function of the load demand. The load demand also necessarily varies with network usage. It is desirable to have only the number of power supplies that will service the load with the individual power supplies operating at as high efficiency as possible. The efficiency characteristics of typical power supplies that are installed in such systems are shown in the representative graph of FIG. 1. While specification sheets for individual models of power supplies will be slightly different, they generally have the shape and values as shown. As is evident, when a power supply is operating at about 25% of its rated output current, it can operate at lower than 65% efficiency. When operating in this area, it is not uncommon for more than one third of the input power to the power supply to be consumed by producing heat. The efficiency of operation is shown to increase to above 70% when the power supply operates in the range of about 50% to about 75% of rated output current, and drops below 70% when operated at 100% of rated output current.

It is a practice of technicians and network administrators to improve the efficiency of operation by simply unplugging or removing power supplies that are not needed to meet the system load. While can increase the efficiency of the remaining operating power supplies, these operating power supplies may not be able to handle service the network if the network load quickly increases.

Accordingly, embodiments of the present invention are directed to apparatus and methods of controlling multiple power supplies to reduce operating costs by reducing energy usage and doing so by controlling multiple power supplies such that only the number of power supplies necessary to meet the system load are enabled or active. Power supplies that are not needed to meet system load are disabled, preferably by placing them in a standby mode. By reducing the number of active supplies to a minimum, the active power supplies operate at a high percentage of output current, where they are more efficient.

In large systems, which can be chassis based servers or large routers or switches, multiple AC or DC input power supplies are typically used to provide the DC voltage(s) needed to operate the system. The systems preferably have slots for receiving the power supplies which may be units that can be inserted and simultaneously connected when fully inserted.

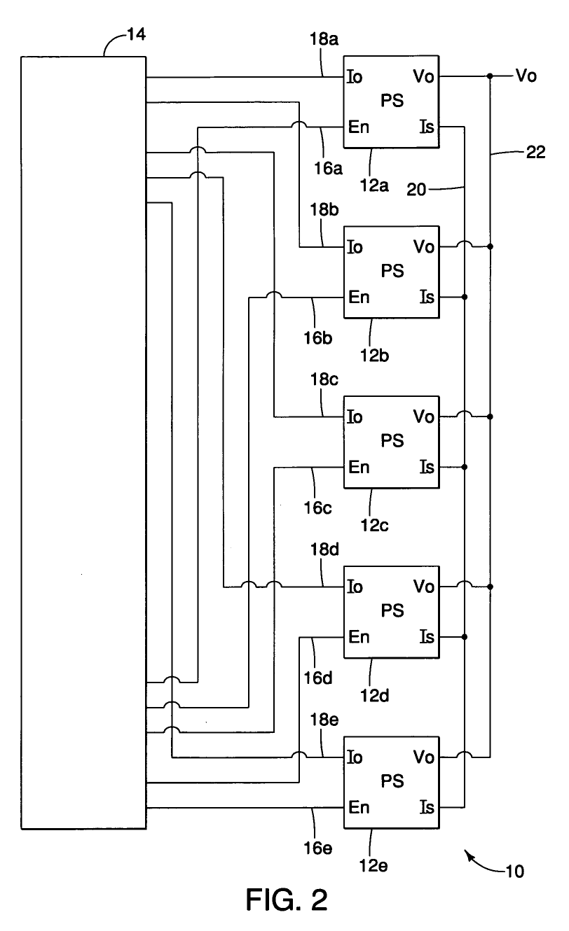

Referring to FIG. 2, a system indicated generally at 10 is shown to have five power supplies 12a-12e that are controlled by a processor 14. The processor 14 can be part of a system processor that controls the operation of the system, or can be a separate small processor that performs a more limited role of monitoring and controlling the operation of the power supplies under its control. Each of the power supplies 12a-12e is enabled by respective enable lines 16a-16e that originate at the processor 14. Additionally, each of the power supplies 12a-12e has its output current (Io) being monitored by respective lines 18a-18e which extend to the processor 14 and which carry a signal proportional to the output current of the power supply. The signal may be a voltage proportional to the output current or may be a digital signal indicative of the output current. The processor 14 thereby monitors the output of the power supplies 12a-12e and thereby can determine the total power that is being output by the power supplies being monitored and controlled.

These power supplies typically have a current share line 20 that connects them in parallel. The current share line keeps all of the power supplies running at approximately the same percentage of output current in a load sharing arrangement. In this regard, current commercially available power supplies preferably have a power sharing port or terminal (Iₛ) that enables such power sharing to be implemented. The output of the power supplies 12a-12e are combined on line 22 which supplies an output voltage (Vₒ) to the system.

The processor 14 monitors the active power supplies that supply the total load to the system and determines whether they are operating efficiently. If the active power supplies are operating at less than 50% output current, then the processor 14 preferably disables one or more additional power supply. This is preferably done sequentially, so that the effect of disabling of one power supply can be determined. Also, if the number of active, i.e., operating, power supplies are running at an upper predetermined percentage of rated output current, e.g., 80+%, the processor preferably enables another power supply inasmuch as the potential for the active power supplies to be unable to handle the load exists. Of course, it should be understood that the predetermined percentage of rated output current can be adjusted based upon the operating characteristics of the system and the criticality of the continuous operability of the system.

A more concrete example of an embodiment of the present invention is a product that has 4 slots for power supplies. If power supplies are put in slots 1, 3, 4 and are each running at 75% of output current capacity, the total load is 3×75%=225%. The processor 14 then must leave all 3 power supplies in an active operating condition, inasmuch as one or two power supplies cannot service the load.

In another example of the same product immediately described above, the three power supplies are running at 40% of output current capacity. Therefore, the total load is 3×40%=120%. The processor 14 preferably disables one of the supplies, leaving the remaining two active power supplies operating at 60% of their rated output current which is a more efficient operation of the system.

From the foregoing description, it should be appreciated that the preferred embodiments of the present invention automatically optimize the operation of the power supplies to enable only the minimum number of power supplies that are needed to meet the load demands at the time.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the following claims.

What is claimed is:

1. A method of optimizing operating efficiency of multiple power supplies that are provided to power a system, the power supplies being selectively operable in an active or standby mode, said method comprising the steps of:
interconnecting at least some of the multiple power supplies in a load sharing configuration;
monitoring the output current of at least one of the interconnected power supplies;
selectively placing the interconnected power supplies in standby mode so that the active power supplies are operating at a relatively high efficiency.

2. A method as defined in claim 1 wherein said relatively high efficiency is at least about 70 percent.

3. A method as defined in claim 1 wherein said power supplies have a current sharing connection, said step of interconnecting said power supplies in a load sharing configuration comprises interconnecting said current sharing connections of said power supplies that are connected in said load sharing configuration.

4. A method as defined in claim 1 wherein said relatively high efficiency is a predetermined range of percentage of rated output current.

5. A method as defined in claim 4 wherein said predetermined range of percentage of rated output current is within the range of about 50 to about 70 percent.

6. A method as defined in claim 1 wherein said step of interconnecting said power supplies comprises connecting the outputs of said power supplies in parallel.

7. A method as defined in claim 1 wherein said step of monitoring the output current comprises monitoring the output current of each of the interconnected power supplies.

8. A method as defined in claim 7 wherein said step of monitoring the output current comprises having a processor connected to each of said power supplies and calculating a total current provided by all active power supplies and determining whether to place additional power supplies in active or standby mode depending upon whether the total output current is within a predetermined range of rated output current.

9. A method as defined in claim 8 wherein said predetermined range of rated output current is between about 25 percent to about 80 percent.

10. A method as defined in claim 9 further comprising selectively placing the interconnected power supplies in active mode in the event said output current is at the upper end of said predetermined range.

11. A method as defined in claim 1 wherein the system comprises at least one of a router, a server and a switch.

12. A method as defined in claim 1 wherein the operating efficiency of the power supplies is low when the power supplies operate at less than about 25 percent of their rated output current.

13. A method as defined in claim 1 wherein said power supplies supply DC output power.

14. Apparatus for optimizing the operating efficiency of multiple power supplies that are provided to power a system, wherein the power supplies are inefficient when they operate at a low percentage of their rated output current, said apparatus comprising:
a plurality of power supplies that are capable of being selectively placed in active mode where they can provide a predetermined DC voltage at a rated output current and standby mode where they provide substantially no output current;
an electrical interconnection for linking the outputs of said plurality of power supplies in a shared load configuration;
a processor operatively connected to at least one power supply to monitor the output current of the power supply, said processor being operative to selectively control the mode of each of said power supplies;
said processor selectively placing one or more of said power supplies in standby mode so that the active power supplies provide output current that is a first predetermined percentage of their rated output current.

15. Apparatus as defined in claim 14 wherein processor selectively places one or more of said power supplies that are in standby mode into active mode if said output current exceeds a second predetermined percentage of their rated output current, wherein said second predetermined percentage is higher than said first predetermined percentage.

16. Apparatus as defined in claim 14 wherein said first predetermined percentage is approximately 25 percent.

17. Apparatus as defined in claim 15 wherein said second predetermined percentage is approximately 80 percent.

18. Apparatus as defined in claim 14 wherein said power supplies have a current share connection port, said apparatus having a line connecting said current share connection ports of said power supplies in parallel.
